(19) United States
(12) Patent Application Publication
(10) Pub. No.: US 2013/0342900 A1
(43) Pub. Date: Dec. 26, 2013

(54) REFLECTION LAYER SYSTEM FOR SOLAR APPLICATIONS AND METHOD FOR THE PRODUCTION THEREOF

(71) Applicants: Christoph Koeckert, Radebeul (DE); Markus Berendt, Dresden (DE)

(72) Inventors: Christoph Koeckert, Radebeul (DE); Markus Berendt, Dresden (DE)

(73) Assignee: VON ARDENNE Anlagentechnik GmbH, Dresden (DE)

(21) Appl. No.: 14/003,926

(22) PCT Filed: Jun. 27, 2011
(86) PCT No.: PCT/EP2011/060722

§ 371 Date: Sep. 9, 2013

(30) Foreign Application Priority Data
Mar. 17, 2011 (DE) 10 2011 005 730.7
Mar. 17, 2011 (DE) 10 2011 005 736.6

(51) Int. Cl. G02B 5/08

(52) U.S. Cl. CPC G02B 5/0875
USPC 359/360; 359/359; 427/162; 427/569; 427/596; 204/192.27; 72/379.2

(57) ABSTRACT

A reflection layer system and a method for the production thereof for front-surface mirrors for solar applications are provided. Deposited on a substrate are a metallic, reflective functional layer, a metallic reflective layer, and a transparent, dielectric protective layer as a top layer containing an oxide, nitride or oxynitride of a metal or semiconductor and having a thickness of 500 nm or more, preferably more than 1 μm

The invention relates to a reflection layer system for front-side mirrors for solar applications having a layer which is highly reflective in the solar spectrum and which is deposited on a substrate. The invention likewise relates to a method for producing a reflection layer system.

Reflection layer systems have already long been in use in many areas of our life; however, nowadays they are becoming more and more important e.g. for mirrors for resolving the energy issue. Whereas mirrors for customary indoor applications need reflect “only” the visible components of the light spectrum, for solar applications they have to reflect the entire range of the solar spectrum as well as possible.

In the case of mirrors, a distinction is made here, in principle, between front-side and rear-side mirrors, depending on which side of the substrate brings about the main reflection.

Reflection layer systems are often produced for indoor and outdoor applications, such as e.g. solar applications (CSP—concentrated solar power), by a reflective coating being deposited on a substrate, e.g. glass or plastic, by means of wet-chemical methods. According to the above definition, this involves mirrors in which the reflective coating is situated either on the rear side of the substrate (rear-side mirror) or on the front side thereof (front-side mirror), in each case relative to the light incidence. Depending on the specific application and the associated requirements in respect of mechanical, chemical and environmentally relevant durability, the reflection coating of the mirrors has to be permanently protected with regard to the atmosphere.

In the case of bent mirrors, such as e.g. for the CSP application in parabolic trough power plants, the bent glass is coated here, in principle. That means that the flat substrate is firstly bent thermally and in the process possibly also toughened or subjected to heat treatment and only then is it coated with the reflection layer or a reflection layer system and possible additional protective layers wet-chemically, physically or in a combination of both methods.

What is crucial for the quality of a solar reflector is, inter alia, the value of its total solar reflectivity (TSR), that is to say its ability to reflect the solar radiation. This value is determined, besides the absorption losses as a result of the substrate even in the case of rear outside mirrors, primarily by the reflectance of its coating. In order to obtain the highest possible reflection, silver is preferably used here as a reflective layer. In the case of rear-side mirrors, a substrate having particularly low absorption and high transparency, e.g. so-called white glass or solar glass, is generally used. On the rear side, the silver layer is in this case then closed off by a copper layer, which simultaneously also serves as an interface layer for the following protective lacquer coatings.

Since such a mirror, in its application, must also withstand high mechanical loads, such as strong wind, and must still be geometrically dimensionally stable even under high loads, the thickness of the substrate cannot fall below a minimum thickness. The thickness of solar mirrors nowadays is usually 4 mm. Despite the use of high-purity white or solar glass, the optical absorption of the substrate material cannot be reduced arbitrarily in the production thereof and therefore constitutes one of the limiting factors with regard to the TSR of a rear-side solar mirror.

The process for producing such mirrors is usually manifested as follows. After appropriate processing required beforehand, which can comprise cutting to the required shape, grinding the substrate edges, bending and/or heat-treating the flat or already bent substrates and other steps, the substrates are, if appropriate, once again polished and washed. Optionally, while still wet they are subsequently provided with a solution having an adhesion promoting action, e.g. tin dichloride, for activation purposes. The sheet then passes successively through coating stations where it is coated wet-chemically with silver and directly afterward with copper. This is then followed directly by the coating of the lacquer or of the various lacquers of the multi-stage lacquer system. Afterward, the entire coating is then dried at 150° C.-200° C.

In the known systems, the applied thicknesses of silver, the material which is important for the reflection but is also cost-intensive, are between approximately 120 nm and 150 nm, which result in relatively high material costs. Moreover, in the case of bent substrates, for example, it proves to be disadvantageous that during the wet-chemical coating of the convex side of the substrate, the initially liquid silver and/or copper solution, owing to the gravitational force, runs to the edges of the substrate and brings about higher layer thicknesses there, which are often in the range of e.g. 150 nm for silver. This effect significantly increases the use of material and leads to inhomogeneities in the layer thickness which, with this order of magnitude, cannot be afforded tolerance for various applications.

Depending on the absorption properties of the substrate and the thickness thereof, for example in the case of a solar glass thickness of 4 mm, mirrors having a TSR of 93%-94% can be produced by means of the method described. This value is below the obtainable values which would result for instance from simulation calculations with correspondingly tabulated optical data for silver.

Therefore, the object is to provide a reflection layer system for solar applications on bent and flat substrates and a method for producing it which can obtain higher TSR values with reduced use of material.

In order to achieve the object, a reflection layer system as claimed in claim 1 and a method for producing it as claimed in claim 13 are proposed. The associated dependent claims present advantageous configurations of the invention.

The reflection layer system according to the invention allows the configuration as a front-side mirror, as a result of which there is a significantly greater variability both with regard to the material of the substrate and with regard to the thickness and shape thereof, without losses in mechanical and chemical durability. This also includes the fact that firstly flat substrates are coated and, after the coating, are bent or subjected to thermal treatment for other purposes. Furthermore, besides glass, e.g. plastic or metal can also be used as substrate. Strip-shaped materials and films are also possible besides plate-shaped materials and films.

According to the invention, the reflection layer system comprises metallic reflection layers which do not have to be optically impervious when considered separately per se. It has been discovered that in order to achieve the maximum solar reflection of the reflection layer system, particularly if it has been sputtered according to one method configuration, the reflection layer thickness required is far less than that used in the wet-chemical method.

An optically impervious layer, also called opaque layer, is a layer whose thickness is such that it no longer exhibits transmission, that is to say that the total solar transmission (TST) is less than 0.1%, and thus attains its maximum reflection or absorption. In the case of silver, a layer is opaque starting from a layer thickness of approximately 100 nm-120 nm. By contrast, if a reflection layer is produced which is significantly thinner than is necessary for achieving the maximum reflection and which thus still exhibits a small proportion of transmission, virtually the same total reflection that would be achieved with an individual opaque reflection layer can be achieved by means of a further reflective layer of some other suitable material, said further reflective layer being arranged behind the highly reflective reflection layer with respect to the direction of light incidence.

In this case, this further material can have a significantly lower individual reflection than the reflection layer, which also allows the use of inexpensive non-noble metals. The second layer arranged behind the reflection layer can therefore serve not only for reflection but also for a supplementary function, in particular for protecting the reflection layer. For this reason, it is designated hereinafter as reflective functional layer, for the sake of better differentiation.

For various material combinations of the reflection layer and the functional layer it may be advantageous for the two layers not to be arranged directly adjacent to one another, but rather for an adhesion promoting layer to be inserted between the two layers. This adhesion promoting layer can have a very small layer thickness; less than 1 nm is sufficient. It is not necessary for the adhesion promoting layer mandatorily to form a closed layer or surface on the functional layer; rather, said adhesion promoting layer can also be regarded as a so-called seed layer.

In order to improve the adhesion of the reflection layer system on the substrate, the substrate surface facing the reflection layer system can be pretreated. In accordance with various configurations of the layer system and of the method used for this purpose, this is possible by a plasma treatment by means of corona discharge or a thermal treatment (heat treatment) under a vacuum. Optionally, it is also possible to deposit an adhesion promoting and diffusion barrier layer on the substrate. This layer, too, need not mandatorily form a closed layer or surface on the substrate and can therefore also be regarded as a so-called seed layer. For this reason, very small layer thicknesses are sufficient here. They are usually less than 5 nm.

The reflection layer systems produced in this way meet the necessary requirements with regard to chemical and thermal durability and adhesive strength, which are tested by various standardized tests. In this case, the pretreatment steps mentioned can also be combined with one another. That also includes the fact that a plasma treatment and/or a heat treatment under a vacuum can be effected in addition to depositing an adhesion promoting and diffusion barrier layer.

With a pretreatment or a combination of a plurality of pretreatments, the chemical activation of the substrates, as used in the case of wet-chemical coating in accordance with the prior art, can be dispensed with.

For improving and for setting the optical properties in a targeted manner, one configuration of the method comprises an alternating layer system comprising at least one layer sequence having a low refractive index dielectric layer and a high refractive index dielectric layer. Such an alternating layer system is suitable here for example, for increasing the reflection.

Furthermore, for the purpose of improving adhesion and at the same time as protection from processes of diffusion into the reflective layers owing to the further processing of the reflection layer system, an adhesion promoting and blocker layer can be arranged between the reflection layer and the alternating layer system. Very small thicknesses in the range of a few nanometers, preferably less than 1 nm, are sufficient for said adhesion promoting and blocker layer, too.

The thin adhesion promoting and blocker layer between the reflection layer and the first layer of the transparent, dielectric and reflection-increasing alternating layer system and likewise the above-described adhesion promoter layer between reflection and functional layers can be deposited from the metallic or ceramic target without or with little additional introduction of oxygen by DC (direct-current) or MF (medium-frequency) sputtering. In this case, significantly less oxygen is required in comparison with fully reactive deposition from the metallic target. Particularly the superficial oxidation of the reflection layer, e.g. of the silver during the sputtering of the adhesion promoting and blocker layer is thus significantly reduced.

The layers produced in this way firstly serve as an adhesion layer between the layers respectively adjacent on both sides, i.e. the metallic reflection layer and a further layer. Secondly, they constitute a protective layer for the reflection layer relative to oxidation in the course of subsequent coating process. This applies particularly when depositing silicon dioxide, which is preferred as the first, low refractive index layer of the alternating layer system and contains oxygen in its plasma.

Furthermore, the adhesion promoting layer and the adhesion promoting and blocker layer can protect the reflection layer against oxidation during the thermal bending and/or heat treatment process. The layer system according to the invention is thus suited, for bent reflection systems, firstly to be deposited on flat substrates and only bent afterward.

In this case, the layer thicknesses of the adhesion promoting layer and of the adhesion promoting and blocker layer are chosen such that exclusively these layers are oxidized during the heat treatment and/or bending, and not the reflection layer, in order thus to achieve the lowest reflection losses. However, the thickness of the layers must be large enough to completely bind the oxygen transported during the thermal treatment via diffusion or to block the diffusion of said oxygen to the reflection layer. Depending on the material, the TSR values obtained after bending, likewise also after a heat treatment, can be higher than before bending. Particularly metals having absorption-free or low-absorption oxides, such as e.g. Al, Zn, Sn, Si, Ti and NiCr, are suitable for this case, wherein for various applications, e.g. for not necessarily highly transparent layers, the oxidation or complete oxidation thereof is not necessary. The adhesion promoting layer and the adhesion promoting and blocker layer can thus be deposited in the metallic or substoichiometrically or stoichiometrically oxidized state.

In addition, the possibility of firstly coating a substrate with the complete reflection layer system or at least some layers thereof and only afterward bending it affords numerous further advantages. On account of the planar property of the substrate, a number of different methods are available for coating, in particular including cathode sputtering, which enables strongly adherent, highly reflective and at the same time very thin layers both on planar and on already bent substrates. In this regard, the known methods enable layer thicknesses with deviations of up to ±1.5%, which allows the homogeneous deposition of the minimum required layer thicknesses on the entire substrate. The more precisely adjustable layer thickness is advantageous for the described reflection layer system having the small layer thicknesses for the functional and reflection layers, since the individual layers which per se are not optically impervious by themselves can thus be produced.

With the described reflection layer system, bent substrate forms are possible with which the reflection layer system is arranged both on the concave, i.e. the inwardly curved, side of the substrate, where the layers are compressed during bending, and on the convex side, which extends the layers during bending. Combinations of both forms are also possible, provided that the substrate supports such bending.

However, wet-chemical methods are likewise possible as well, which can be used to produce uniform layers on the planar substrate. By way of example, the sol-gel method can be employed, which involves depositing generally non-metallic inorganic or hybrid-polymeric materials composed of colloidal dispersions, the so-called sols. For coating purposes, the coating solutions are firstly applied on the substrate and then dried, optionally under the action of temperature. Throughout coating and drying, the hydrolysis and condensation reactions progress until the aggregation has become a solid film.

At all events and on account of the resultant material saving of the layer material, the different deposition methods lead to a significant cost saving in comparison with the methods according to the prior art.

Supplementarily or alternatively, the adhesion promoting and diffusion barrier layer can also be produced on the substrate like the above-described adhesion promoting layer and adhesion promoting and blocker layer with regard to material and thickness, in order by means of this layer, too, as described above, to obtain protection of the functional and reflection layers against the oxidation thereof during the bending or heat treatment. For the function and for the construction of this layer, reference is therefore made to the above explanations concerning the adhesion promoting and blocker layer.

The termination of the reflection layer system is formed by a thick, transparent dielectric cover layer composed of an oxide, nitride or oxynitride of a metal or semiconductor. In this case, thick is regarded as layer thicknesses of at least 500 nm in order to obtain a sufficient mechanical and chemical durability, without having to accept significant losses in the TSR value. Layer thicknesses of more than 1 pm may also be necessary depending on these requirements.

Surprisingly, it has been found that the thick cover layer also supports thermal bending or heat treatment after the deposition of the reflection layer system, since the bent reflection layer systems according to the invention having a thick cover layer composed of an oxide, nitride or oxynitride of a metal or semiconductor exhibit at least identical TSR values in comparison with customary cover layers having significantly smaller layer thicknesses.

This suitability of the thick cover layer for thermal bending and/or heat treatment can be promoted further if said layer, according to various configurations, is varied in terms of its proportional material composition and, associated therewith, its morphology over the thickness. This can be done by depositing discrete sublayers having mutually different metal or semiconductor and oxygen and/or nitrogen proportions. Alternatively, gradient layers are also suitable, the proportional material composition of which changes continuously with the layer thickness. Particularly on account of the high layer thickness, combinations of both embodiments in one cover layer are also possible, that is to say that discrete sublayers are deposited, at least one, alternatively also a plurality of which is/are embodied as a gradient layer.

Possible layer thicknesses for the reflection layer system according to the invention can be determined by means of optical simulation calculations, for example. In this regard, it has been established that with a layer system, e.g. consisting of an at least 65 nm thick silver layer as reflection layer R and, situated behind the latter, an approximately 45 nm thick, reflective functional layer F composed of a different metal, it is possible to obtain a total solar reflection that is lower only by approximately 0.1%, compared e.g. with a 120-150 nm thick, that is to say optically impervious silver layer with arbitrary other layers behind it. This constitutes a huge material cost saving of almost 50%.

The materials used for the reflection layer R can deviate from silver indicated above. According to the invention, such metals, e.g. such as aluminum, gold, platinum, are also possible, or an alloy containing at least one of the stated materials. The metals mentioned all have a comparably high solar reflection, if appropriate for specific wavelengths such as gold and platinum, and are therefore suitable for the reflection layer system. The required minimum layer thicknesses can be determined if appropriate by experiments or by simulation depending on the material of the metallic, reflective functional layer F, such that the maximum reflection can be obtained. By way of example, a minimum silver layer thickness of 60 nm was determined for the above layer combination of silver with copper, and the silver layer thickness is preferably between 40 nm and 100 nm, especially between 60 and 90 nm, for the layer combination of silver with copper.

Materials such as e.g. copper, nickel, chromium, high-grade steel, silicon, tin, zinc, molybdenum, or an alloy containing at least one of the metals, are appropriate as metallic, reflective functional layer F. With these materials, the reflective properties can be combined with mechanical and/or chemical protection.

Various materials can also be used for the dielectric layers of the alternating layer system, wherein the refractive indices are assessed as high and low refractive index relative to one another. By way of example, titanium oxide or else niobium oxide (Nb₂O₅), can be used as a high refractive index layer. By way of example, silicon oxide or aluminum oxide (Al₂O₃) or magnesium fluoride (MgF₂) can be used as low refractive index. For the material combination it is necessary to take account of the change in the refractive indices for obtaining the reflection-increasing effect.

On account of the embodiment of the reflection layer system as a front-side mirror and the above-described reflection-fostering measures, which can also be applied to subsequently bent mirrors, it is possible to obtain reflection values which, with 96% TSR or above, are a few percent above the values known from rear-side mirrors. As materials, by way of example, TiO₂ or Nb₂O₅ proves to be advantageous for the high refractive index dielectric layer of the optional alternating layer system and SiO₂, Al₂O₃ or MgF2, on account of its optical, mechanical and/or chemical properties, proves to be advantageous for the low refractive index dielectric layer.

The invention will be explained in greater detail below on the basis of exemplary embodiments. In the associated drawings,

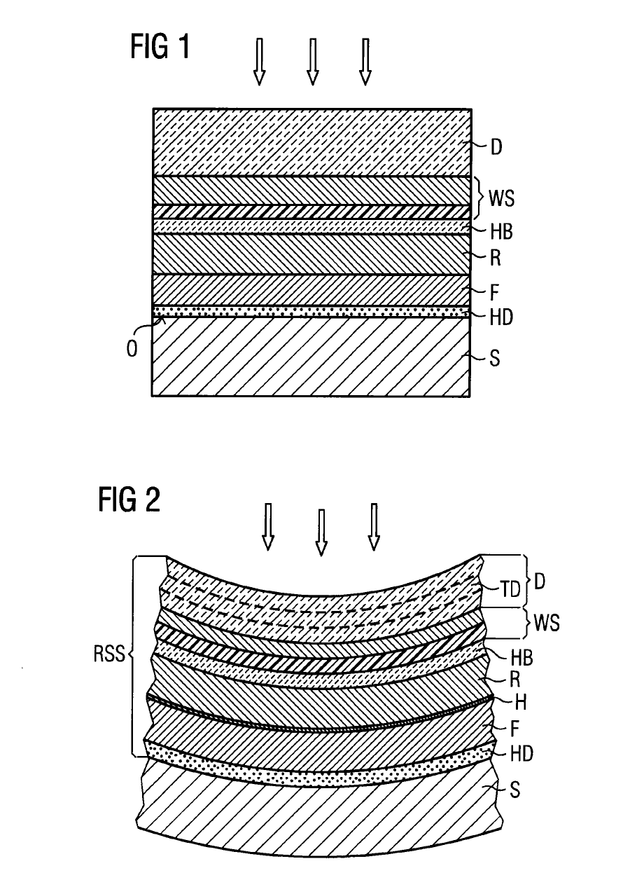

FIG. 1 shows a reflection layer system as a front-side mirror, and

FIG. 2 shows a reflection layer system as a front-side mirror on a bent substrate.

A reflection layer system according to the invention has, in an embodiment in accordance with FIG. 1, the following layer construction having the stated layer thicknesses as viewed upward from the substrate in the direction of light incidence (identified by arrows):
S substrate
HD aluminum-doped zinc oxide (ZAO) or titanium oxide
(TiO₂); 3 nm
F nickel-chromium (NiCr); 45 nm
R silver (Ag); 75 nm
HB ZAO or TiO₂; 1 nm
WS silicon oxide (SiO₂); 58 nm and TiO₂; 27 nm
D SiO₂ or silicon oxynitride (SiOₓN_{y}); 1200 nm

A total solar reflection according to ISO 9050:2003 of more than 96% was obtained with such a reflection layer system of a front-side mirror.

In order to produce the layer system, the layers are deposited successively by magnetron sputtering on the correspondingly carefully polished, washed and dried substrate S, e.g. float glass. Alternatively, combinations of magnetron sputtering with other PVD methods, e.g. electron beam evaporation, or CVD or PECVD methods or else wet-chemical coating methods are also possible.

Prior to coating by sputtering, the substrate S can optionally be subjected to a plasma pretreatment in a vacuum. For this purpose, e.g. in a rarefied gas atmosphere, which can contain argon, oxygen, CDA (compressed dry air) or nitrogen or arbitrary mixtures thereof, at a pressure of 2-5 10⁻² mbar, a DC or MF corona discharge is ignited, to which that side of the substrate which is to be coated later is exposed. The corona duration is 0.5 to 5 minutes.

Alternatively, the substrate S can also be heated prior to coating. Depending on the pretreatment step, which can also be combined, one or a plurality of adhesion layers HS can then optionally be deposited.

In the exemplary embodiment, the single adhesion promoting and diffusion barrier layer HD is deposited from the metallic target in the fully reactive MF mode of the sputtering characteristic of the target material with additional introduction of oxygen. Alternatively, however, it can also be deposited from the ceramic target with or without additional introduction of oxygen in the DC or MF mode. In the case of reactive coating from the metallic target in the MF mode, the sputtering process is operated in the oxidic mode. A particularly intensive plasma associated with low sputtering rates is realized in this case. This leads to improved removal of the water always bound to the substrate surface, and the optimum formation of an adhesion promoting and diffusion barrier layer HD, which only has to be deposited very thinly with a value of less than 5 nm. Furthermore, carbon-containing impurities, which usually have a very adverse effect on the adhesive strength, are oxidized to form gaseous carbon dioxide that can be transported away via the vacuum pumps.

The two metallic reflective layers F, R are deposited from the metallic target by DC sputtering or by pulsed DC sputtering. They consist of nickel-chromium and silver, respectively, in the exemplary embodiment. Alternatively, they can also consist of another of the materials mentioned above.

In this case, the thin adhesion promoting and blocker layer HB between the reflection layer R and the first layer of the transparent, dielectric and reflection-increasing alternating layer system WS is deposited from the ceramic target by DC, pulsed DC or MF sputtering. As also in the case of the adhesion promoting and diffusion barrier layer HD, this can be effected without or with little additional introduction of oxygen, wherein significantly less oxygen is required in comparison with reactive deposition from the metallic target. The superficial oxidation of the silver during the sputtering of this adhesion promoting and blocker layer HD is significantly reduced as a result. The adhesion promoting and blocker layer HB is also required only with a very small thickness, to be precise less than 1 nm. The layer thus produced firstly serves as an adhesion layer between the metallic silver and the dielectric alternating layer system WS. It secondly constitutes a protective layer for the silver in relation to oxidation by the subsequent reactive deposition process, in particular during the deposition of silicon dioxide that is preferred as the first layer of the alternating layer system WS and the plasma of which contains oxygen during coating.

The next process is deposition of an alternating layer system comprising at least one low and one high refractive index dielectric layer in the reactive MF mode, e.g. low refractive index SiO₂ and high refractive index TiO₂.

This is then followed by a sufficiently thick protective layer as cover layer D. This protective layer must be highly transparent and, like the two layers of the alternating layer system as well, can be produced by physical vapor deposition (PVD) e.g. by reactive MF sputtering or electron beam evaporation, by CVD or PECVD or else wet-chemically (WCD).

The deposition of the various layers can, as described, preferably be effected by suitable sputtering methods, whereby particularly dense and compact layers can be produced. The reason for this is the high particle energies of the layer-forming particles deposited in this way during coating in a vacuum. In this case, the electrical and optical properties of such layers almost reach those of the corresponding solids. A suitable choice of the deposition parameters makes it possible to influence the crystal structure of the layers in wide ranges.

A further advantage of the use of PVD technology is the fact that extremely homogeneous layer thickness distributions can be realized even over large substrate widths. By way of example, layer thickness deviations from the average value of less than +/−1.5% can be obtained for large-area architectural glass applications over substrate widths of 3.21 m.

Over and above the variants of the sputtering method that are preferred above for the individual layers, with regard to composition and layer structures the properties thereof can be influenced further in a targeted manner. In order to fulfill particular requirements made of various layers, the incorporation of wet-chemical methods is optionally also possible.

Optionally, it is possible to heat the substrate with the sputtered layer system after silver coating or else only after the coating of one of the subsequent layers in a vacuum before the coated sheet is discharged e.g. from the vacuum installation. In this case, the heating of the sputtered layers brings about the formation of a crystal structure that is optimal with regard to the reflection of silver, and thus leads to even higher TSR values.

Since layers having the desired layer thickness at all points can be deposited by the PVD method and since layers deposited in this way cannot “run away”, the method according to the invention, besides planar substrates, is particularly suitable also for bent substrates having at least in sections bent, convex or concave shapes.

FIG. 2 illustrates a configuration of the reflection layer system RSS according to the invention on a bent substrate, wherein the deposition of the reflection layer system RSS in accordance with FIG. 1 was modified in such a way that bending can take place after the deposition of the reflection layer system RSS and the high TSR values mentioned can nevertheless be obtained.

The above-explained composition of the reflection layer system RSS is also used for the bendable variant. In this respect, reference can be made to the explanations above.

Differences consist merely in the deposition of a supplementary thin, i.e. less than 1 nm thick, adhesion promoting layer H between the functional and reflection layers and the deposition mode of the adhesion promoting and barrier layer HB and adhesion promoting and diffusion barrier layer HD. As material for adhesion promoting layer H, the same materials are available as for the adhesion promoting and barrier layer HB and adhesion promoting and diffusion barrier layer HD, i.e. a metal or an oxide of Zn, Si, Sn, Ti, Zr, Al, Ni, Cr or of a compound thereof.

These three layers are deposited from the metallic target by DC sputtering, pulsed DC sputtering or MF sputtering from the ceramic target without or with only little additional introduction of oxygen, such that the proportion thereof relative to the introduction of the inert process gas is less than 10%. Therefore, these layers are present in the unoxidized or only incipiently oxidized state directly after coating.

In the exemplary embodiment in accordance with FIG. 2, the cover layer is furthermore produced from two discrete sublayers TD of silicon oxide or silicon oxynitride, with the nitrogen proportion increasing toward the surface of the reflection layer system RSS.

In a subsequent process step, the substrate S coated with this reflection layer system RSS is cut to size, ground at its edges and subsequently bent thermally. In this case, the substrate S is bent thermally, i.e. heated to a temperature above its softening point, in the range of approximately 600 to 650° C. in the case of glass, and brought to the desired shape. By way of example, gravitation bending furnaces that operate in this temperature range are known here. Depending on the final temperature and cooling method, the coated substrate S can in this case at the same time also be subjected to heat treatment and/or toughened. Furthermore, structural defects of the reflection layer system RSS anneal during this treatment and provide for even higher TSR values. The bending process can take place under protective gas or in air, depending on the coating.

With the reflection layer system RSS in accordance with FIG. 2, it was possible to further increase the TSR values compared with that in FIG. 1 after bending. A TSR value of greater than 97% was thus obtained.

### LIST OF REFERENCE SIGNS

S Substrate
O Pretreated surface
HD Adhesion promoting and diffusion barrier layer
F Metallic, reflective functional layer
H Adhesion promoting layer
R Metallic reflection layer
HB Adhesion promoting and blocker layer
WS Alternating layer system
D Cover layer
TD Sublayer
RSS Reflection layer system

1. A reflection layer system for solar applications, comprising the following constituents as viewed upward from a substrate:
a substrate,
a metallic, reflective functional layer,
a metallic reflection layer, and
a transparent, dielectric protective layer as cover layer containing an oxide, nitride or oxynitride of a metal or semiconductor, and having a thickness of 500 nm or more.

2. The reflection layer system as claimed in claim 1, wherein the metallic reflection layer and the metallic, reflective functional layer together have a thickness such that they are jointly optically impervious, but that is not the case for one or both of the metallic reflection layers and the metallic, reflective functional layer per se.

3. The reflection layer system as claimed in claim 1, wherein the metallic reflection layer is arranged adjacent to the metallic, reflective functional layer.

4. The reflection layer system as claimed in claim 1, wherein the metallic, reflective functional layer comprises copper, nickel, chromium, high-grade steel, silicon, tin, zinc, molybdenum or an alloy containing at least one of the materials mentioned, and/or the reflection layer comprises silver, aluminum, gold, platinum or an alloy containing at least one of the materials mentioned.

5. The reflection layer system as claimed in claim 1, wherein the substrate has at least one pretreated surface.

6. The reflection layer system as claimed in claim 1, wherein an adhesion promoting and diffusion barrier layer is arranged between the substrate and the metallic reflective functional layer.

7. The reflection layer system as claimed in claim 1, wherein an adhesion promoting and blocker layer is arranged above the metallic reflection layer.

8. The reflection layer system as claimed in claim 1, wherein an adhesion promoting layer is arranged between the metallic, reflective functional layer and the metallic reflection layer.

9. The reflection layer system as claimed claim 8, wherein the adhesion promoting layer contains a metal or a stoichiometric or substoichiometric oxide of Zn, Si, Sn, Ti, Zr, Al, Ni, Cr or of a compound thereof.

10. The reflection layer system as claimed in claim 1, wherein the cover layer comprises a plurality of discrete sublayers and/or comprises one or a plurality of gradient layers having varying proportions of material constituents.

11. The reflection layer system as claimed in claim 1, wherein a dielectric alternating layer system comprising at least one layer sequence having a low refractive index dielectric layer and a high refractive index dielectric layer is arranged below the cover layer.

12. The reflection layer system as claimed in claim 1, wherein substrate has at least in sections a convex and/or concave bend.

13. A method for depositing a reflection layer system as claimed in claim 1, wherein at least the following layers are deposited successively on the substrate:
a metallic, reflective functional layer,
a metallic reflection layer, and
a transparent, dielectric protective layer as cover layer composed of an oxide, nitride or oxynitride of a metal or semiconductor, and having a thickness of 500 nm or more.

14. The method for depositing a reflection layer system as claimed in claim 13, wherein the metallic reflection layer and the metallic, reflective functional layer are deposited together with a thickness such that they are jointly optically impervious, but that is not the case for one or both of the metallic reflection layer and the metallic, reflective functional layer per se.

15. The method for depositing a reflection layer system as claimed in claim 13, wherein at least one surface of the substrate is pretreated prior to coating.

16. The method for depositing a reflection layer system as claimed in claim 13, wherein an adhesion promoting and diffusion barrier layer is deposited between the substrate and the metallic, reflective functional layer.

17. The method for depositing a reflection layer system as claimed in claim 13, wherein an adhesion promoting and blocker layer is deposited above the reflection layer.

18. The method for depositing a reflection layer system as claimed in claim 13, wherein an adhesion promoting layer is deposited between the metallic, reflective functional layer and the metallic reflection layer.

19. The method for depositing a reflection layer system as claimed in claim 16, wherein the adhesion promoting and diffusion barrier layer (HD) is deposited as a layer containing a metal or an oxide of Zn, Si, Sn, Ti, Zr, Al, Ni, Cr or other compound thereof

20. The method for depositing a reflection layer system as claimed in claim 16, wherein the adhesion promoting and diffusion barrier layer (HD) is deposited by DC sputtering, pulsed DC sputtering or MF sputtering from a ceramic target without or with only little additional introduction of oxygen, having a proportion less than 10% relative to introduction of an inert process gas.

21. The method for depositing a reflection layer system as claimed in claim 18, wherein the adhesion promoting layer is deposited from a metallic target without or with only little additional introduction of oxygen, having a proportion less than 10% relative to introduction of an inert process gas, and is oxidized in a subsequent process step.

22. The method for depositing a reflection layer system as claimed in claim 21, wherein oxidation of the adhesion promoting layer is effected by thermal bending or by heat treatment of the coated substrate.

23. The method for depositing a reflection layer system as claimed in claim 13, wherein the cover layer is deposited as a plurality of discrete sublayers and/or with one or a plurality of gradient layers, wherein proportions of material constituents vary within the cover layer.

24. The method for depositing a reflection layer system as claimed in claim 13, wherein the cover layer is deposited by reactive MF sputtering or electron beam evaporation or by CVD or PECVD methods or wet-chemically.

25. The method for depositing a reflection layer system as claimed in claim 13, wherein a dielectric alternating layer system comprising at least one layer sequence having a low refractive index dielectric layer and a high refractive index dielectric layer is deposited below the cover layer.

26. The method for depositing a reflection layer system as claimed in claim 25, wherein the alternating layer system is deposited by reactive medium-frequency sputtering or electron beam evaporation.

27. The method for depositing a reflection layer system as claimed in claim 13, wherein one or a plurality of layers of the reflection layer system is/are deposited by wet-chemical method.

28. The method for depositing a reflection layer system as claimed in claim 13, wherein the substrate is subjected to thermal treatment after coating with the metallic reflection layer and the metallic, reflective functional layer, or after coating of a following layer.

29. The reflection layer system as claimed in claim 1, wherein the transparent, dielectric protective layer has a thickness of more than 1 μm.

30. The method for depositing a reflection layer system as claimed in claim 13, wherein the transparent, dielectric protective layer has a thickness of more than 1 μm.

31. A method for producing a bent front-side mirror, wherein a reflection layer system is deposited on a flat substrate according to the method as claimed in claim 13, and the coated substrate is afterwards bent so that the reflection layer system is located on a convex and/or a concave side of the bent substrate.

32. The method for producing a bent front-side mirror as claimed in claim 31, wherein the coated substrate, at same time of bending, is also subjected to heat treatment and/or toughened.
